(19) United States
(12) Patent Application Publication
(10) Pub. No.: US 2010/0008248 A1
(43) Pub. Date: Jan. 14, 2010

(54) NETWORK TESTER FOR REAL-TIME MEASURING OF TCP THROUGHPUT

(76) Inventors: Barry Constantine, Mount Airy, MD (US); James Rayno, Frederick, MD (US); Mirna Mekic, Gaithersburg, MD (US); Kanwaljit Singh Rekhi, Montgomery Village, MD (US); Anand Gajjala, Herndon, VA (US)

Correspondence Address: Pequignot + Myers LLC, 140 Marine View Avenue, Suite 220, Solana Beach, CA, 92075, US

(21) Appl. No.: 12/499,363

(22) Filed: Jul. 8, 2009

Related U.S. Application Data
(60) Provisional application No. 61/078,896, filed on Jul. 8, 2008.

(51) Int. Cl. H04L 12/26

(52) U.S. Cl. 370/252

(57) ABSTRACT

The invention relates to a method for real time testing of TCP traffic in a network, the method comprising: (a) connecting a tester to the network; (b) requesting connectionless traffic from a remote device connected to the network, to the tester; (c) generating the connectionless traffic comprising a plurality of packet streams, with the remote device, and receiving the connectionless traffic by the tester; (d) generating TCP traffic comprising a plurality of TCP sessions between the tester and the remote device; and, (e) concurrently with steps (c) and (d), in real time collecting statistics of the TCP sessions using the tester. The tester has an-FPGA implemented traffic engine, including a TCP state machine, for generating and receiving traffic at the rates of at least 1 gigabit per second, and for collecting statistics in real time.

### CROSS-REFERENCE TO RELATED APPLICATIONS

The present invention claims priority from U.S. Provisional Patent Application No. 61/078,896 filed Jul. 8, 2008, which is incorporated herein by reference for all purposes.

### TECHNICAL FIELD

The present invention relates to packet-based communications, and, in particular, to active real-time testing of multiple services provided to a customer.

### BACKGROUND OF THE INVENTION

The telecommunication networks provide a growing number of packet-based services, such as Voice over IP (VoIP), gaming, video conferencing, IP Television (IPTV), video-on-demand (VOD), and so on. These services all share parts of the same distribution network and thus may affect each other performance. Various class-of-service (CoS) mechanisms are implemented in the networks to manage the competition of the services for the network bandwidth. Assessment tools monitor and analyze network-level service performance in terms of Quality of Service (QoS) parameters and compliance with service level agreements (SLAs).

With reference to FIG. 1, in a typical triple-play scenario, streams of Ethernet frames, e.g. video streams (IPTV ch1 and ch2), voice streams (VoIP call1 and call2), and data streams (HTTP and ftp), travel over a shared physical link, e.g. DSL or Ethernet. The Ethernet frames are classified based on their MAC addresses (source and destination), VLAN ID and priority, and IP source and destination addresses. All the parameters are encoded in various headers, including an Ethernet header and an IP header. A stream is a plurality of Ethernet frames with the same Ethernet and IP headers, i.e. the same parameters. Different streams may be assigned to different VLANs and have different priority in order to guarantee their respective QoS. Typically, video and voice streams are given a higher priority than data, since there is a greater need for real time video and voice transmission.

In a typical network, various different types of traffic, e.g. video, data and VoIP, are constantly being added and dropped. Moreover, certain types of traffic, e.g. video, increase at certain times of day, thereby affecting the other types of traffic on the network.

In order to test compliance of a network to SLAs, a conventional testing device simulates bulk traffic associated with different services, such as IPTV. The tester generates a plurality of streams formed of Ethernet frames, which have an appropriate header and may be stuffed with zeroes to simulate payload.

Services provided to a customer over the internet, for example IPTV, generally include two types of traffic: connectionless streams delivering the service, video frames in our example, and connection-oriented sessions between the customer and the service provider, for delivering control information and statistics. The connectionless traffic forms the bulk of the total traffic associated with the service and the testing devices monitor or simulate such traffic in order to evaluate QoS provided by the network. However, a satisfactory level of QoS parameters does not always guarantee a satisfactory user experience because the connection-oriented traffic may create a bottleneck.

An object of the present invention is to overcome the shortcomings of the prior art by providing a network tester capable of testing in real-time connectionless and connection-oriented traffic associated with a service provided to a user over a network.

### SUMMARY OF THE INVENTION

Accordingly, the present invention relates to a method for real time testing of TCP traffic in a network, the method comprising: (a) connecting a tester to the network; (b) requesting connectionless traffic from a remote device connected to the network, to the tester; (c) generating the connectionless traffic comprising a plurality of packet streams, with the remote device, and receiving the connectionless traffic by the tester; (d) generating TCP traffic comprising a plurality of TCP sessions between the tester and the remote device; and, (e) concurrently with steps (c) and (d), in real time collecting statistics of the TCP sessions using the tester.

Another aspect of the present invention relates to a portable tester for real-time testing of a TCP throughput in a network, the tester comprising: an interface for transmitting and receiving packets over the network at a rate of at least one gigabit per second; a traffic generator for providing TCP packets of at least 64 concurrent TCP sessions to the interface and for providing background traffic to the interface, the background traffic formed of simulated connectionless streams of packets; a measuring system for collecting statistics associated with the TCP sessions in real time; and, a test controller for controlling the traffic generator for providing the background traffic concurrently with the TCP sessions so as to measure the TCP throughput in dependence on the background traffic.

Another feature of the present invention provides an FPGA-implemented traffic engine, including a TCP state machine, for generating and receiving traffic at the rates of at least 1 gigabit per second, and for collecting statistics in real time.

### BRIEF DESCRIPTION OF THE DRAWINGS

The invention will be described in greater detail with reference to the accompanying drawings which represent preferred embodiments thereof, wherein:

FIG. 1 is a schematic representation of the packet flows received by a customer;

FIG. 2 is a flow chart of the method of network testing;

FIG. 3 is a schematic representation of a test setup;

FIG. 4 is a block schema of a tester;

FIG. 5 is a block schema of the traffic engine configuration;

FIG. 6 is a screen output of TCP Walk the Window script configuration;

FIG. 7 is a screen output of TCP Walk the Window script results;

FIG. 8 is a screen output of TCP streams and background streams configuration;

FIG. 9 is a “Network Pipe” view of TCP and IP streams profile;

FIG. 10 is a screen output of test results: TCP throughput is stable as UDP traffic rises; and,

FIG. 11 is a screen output of test results: TCP throughput degrades as UDP traffic rises.

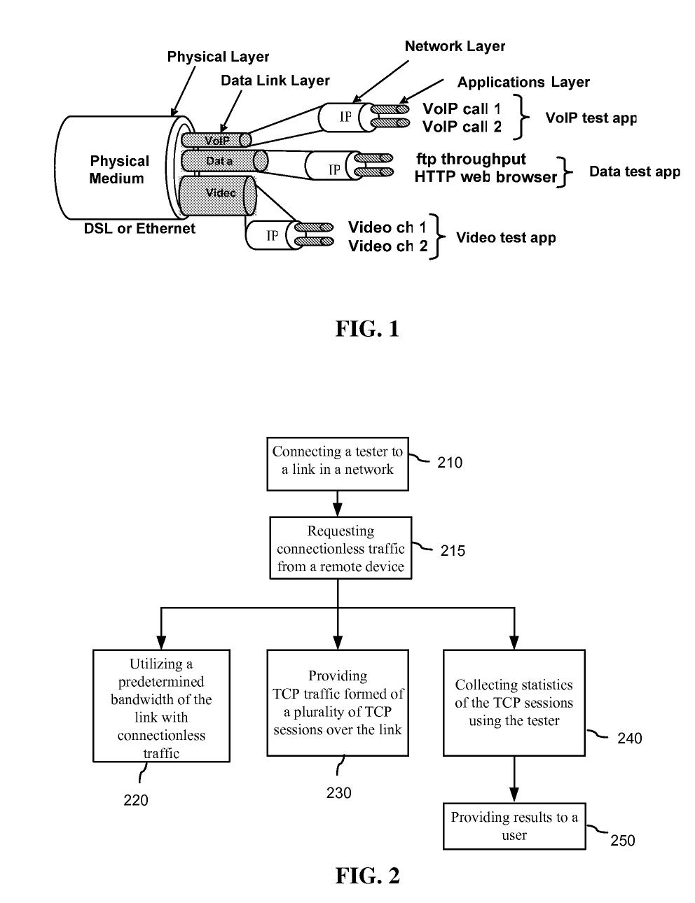

### DETAILED DESCRIPTION

As communication providers strive to improve their Ethernet service turn-up processes, the fundamental goal is to provide their customers with the expected service quality. Closely coupled to this goal is the ability to verify that the network is performing acceptably in cases when a customer complains that his applications are slow due to the network.

Currently, in the turn-up process of Ethernet service, communication providers verify the ability of a network to meet various SLAs for performance in Layer 2 (Ethernet) and Layer 3 (IP). Generally these SLAs specify throughput, loss, delay, and jitter limit parameters under varying network loads. Since connectionless traffic formed of video, voice and data packet streams constitutes the bulk of the network load, the practice of the field technicians is generally limited to testing the throughput and other parameters of one or more streams carried by connectionless protocols, e.g. UDP.

However, it has been noticed by the inventors that compliance with SLA requirements for performance in Layers 2 and 3 does not guarantee the quality of the user experience which might have been expected. In other words, it has been noticed that field technicians often have to investigate customer complaints related to network links where SLAs are known to be satisfied. It turned out that the problem often relates to TCP-based control traffic providing signaling, statistics reports, and the like. The TCP-based traffic requires significantly less bandwidth than, for example, video streams, but, because of its role, it may impede the service and deteriorate the user experience if congested.

Conducting a turn-up test emulating real customer traffic at full line rate up to 10 GigE enables the communications provider to confidently activate a new customer and to resolve post turn-up problems. A classic example is misconfiguration of TCP settings at the customer site. In this case, upon a service turn-up with conventional Level 2 and 3 testing, the provider immediately gets a complaint from the customer concerning slow network performance. An additional trip of a field support engineer to the customer site is required to validates the network SLA by running Layer 4 tests, usually by using laptop computers.

In this example, the customer dissatisfaction and additional workload for the field engineer could have been eliminated if the network was also tested from the application perspective. With Layer 4 enabled test equipment, a technician can easily run Layer 4 throughput tests and deliver a service turn-up report, which would identify the specific TCP settings used to achieve the promised SLA.

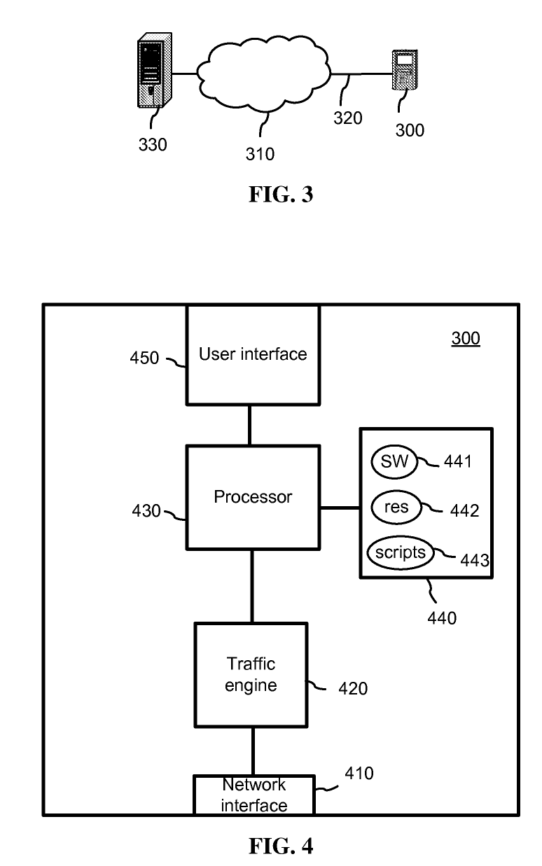

Accordingly, a new method of network testing and a device implementing the method have been designed. With reference to FIGS. 2 and 3, a portable tester 300 is connected to a link 320 in a network 310, a connecting step 210. Then, in traffic requesting step 215, connectionless traffic is requested from a remote device 330 connected to the network 310, for example by controlling the remote device 330 over the network 310. The remote device 330 may be another tester similar to the tester 300. In a bandwidth utilization step 220, the tester 300 receives connectionless traffic from the remote device 330, so as to utilize a predetermined bandwidth according, e.g., to test requirements.

The connectionless traffic is formed of one or more streams carried by a connectionless protocol, for example UDP. The streams are simulated streams formed of packets utilizing stuffing bytes as payload, with video, voice or data stream header parameters as described in U.S. Patent Application No. 20090034596 filed Jul. 30, 2008, in the name of Chen et al., incorporated herein by reference. The packets within the streams are Ethernet packets/frames, which encapsulate IP packets or packets compliant with another protocol.

In a TCP traffic step 230, the tester 300 initiates a plurality of TCP sessions with the remote device 330. The tester 300 can generate either a single TCP session or a multitude of TCP sessions, depending upon the level to which application traffic emulation is desired. Alternatively, the TCP sessions between the tester 300 and the remote device 330 can be initiated by the remote device 330.

Further, a statistics collecting step 240 is performed concurrently with the bandwidth utilization step 220 and the TCP traffic step 230. The tester 300 in real time collects statistics related to the received TCP traffic, including a number of TCP retransmissions, a round trip delay parameter, maximum TCP window size, and a number of lost segments in all concurrent TCP sessions.

In a result step 250, the statistics are processed and results are provided to the technician, for example via a graphical interface.

According to the invention, the bandwidth utilization step 220, the TCP traffic step 230, and the statistics collecting step 240 have to be executed concurrently, since the TCP traffic step 230 provides an entity to be tested, the bandwidth utilization step 220 provides the test environment, and the statistics collecting step 240 performs real-time measurements.

The connectionless traffic and the TCP traffic received by the tester 300 are concurrent in the sense that two consecutive packets of the TCP traffic may be separated by one or more packets of the connectionless traffic. The concurrency of the statistics collecting step 240 with the traffic steps 220 and 230 means that the measurements are performed in real time upon receiving the TCP traffic and not using a posteriori analysis of TCP logs.

The method is designed for testing in today's network where packets are transmitted at a rate of 10 Gigabit per second or at least 1 Gigabit per second. To enable the real-time statistics collection, the tester 300 has an FPGA-implemented traffic engine for processing of packets received at the rate of at least 1 Gigabit per second and for collecting the statistics.

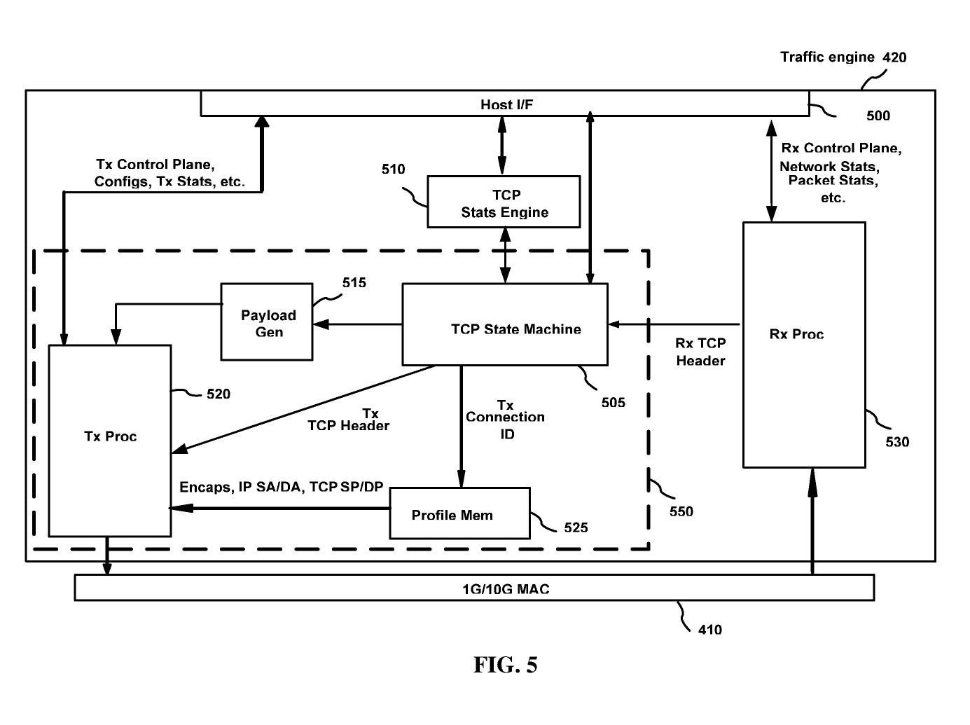

A tester 301, which provides the functionality of the tester 300 and of the remote device 330 and may be used as either of them, will be further described with reference to FIG. 4. The tester 301 includes a user interface 450, a processor 430, a memory means 440, a traffic engine 420, and a network interface 410.

The user interface 450 may include a keypad and an output screen; the interface 450 allows a technician to initiate the test process and choose test parameters, for example by entering the parameter values using the keypad or by selecting a test script stored in the memory 440. Accordingly, the memory 440 stores software 441 to be executed by the processor 430, test results 442, and preferably test scripts 443. The software 441 includes a test controller for controlling the traffic generator within the traffic engine 420 for providing background traffic concurrently with TCP sessions so as to measure the TCP throughput in dependence on the background traffic.

While executing instructions of the software 441, the processor 430 provides configuration parameters for the TCP connections, or sessions, and for the connectionless IP streams, to the traffic engine 420. The configuration parameters for each of the TCP sessions include IP source and destination addresses and TCP source and destination ports. A number of simultaneous TCP connections and a maximum window size for each connection are also provided by the processor 430 to the traffic engine 420. The IP stream configuration includes IP addressing, a packet/frame size, a traffic load rate, and a traffic load type. The traffic load type may be characterized by a constant bit rate or a ramping bit rate.

The network interface 410, preferably an Ethernet interface, is for transmitting and receiving packets over the network 310 at a rate of at least one gigabit per second. In one embodiment, the network interface 410 is capable of receiving packets at a rate of 10 gigabit per second.

FIG. 5 illustrates a configuration of the traffic engine 420 which enables multiple TCP sessions and the multiple background IP stream packets. To implement the aforedescribed method of the TCP throughput testing, the tester 301 has to provide at least 64 connections to fully qualify a GigE link and preferably up to 128 sessions, especially for 10 GigE links. The implementation of the blocks within the traffic engine 420 would be known to a person skilled in the art. Preferably, they are implemented in a field-programmable gate array (FPGA).

A host interface 500 interfaces to the tester's host processor 430 and provides the configuration parameters for the TCP connections and IP streams. The host interface 500 also enables retrieval of test results by the processor 430 and their display using the user interface 450.

The tester's host software 441, upon user input, establishes the TCP connections and a TCP state machine 505 maintains the connections and conducts the core TCP throughput measurements. The TCP state machine 505 is responsible for all aspects of the TCP connection, once it has been established, as defined in RFCs 793, 1323, 2581, etc.

The TCP state machine 505 may be implemented as described in U.S. Pat. No. 7,181,544 issued Feb. 20, 2007, in the name of Vangal et al., or in U.S. Pat. No. 6,996,070 issued Feb. 7, 2006, in the name of Starr et al., both patents incorporated herein by reference. Preferably, the TCP state machine 505 is implemented in FPGA.

A payload generator 515 and a transmission (TX) processor 520 generate the background IP streams and multiplex these streams with the TCP traffic received from the TCP state machine 505. The TCP state machine 505 only provides TCP headers while the payload generator 515 and the TX processor 520 construct the remaining portion of the outgoing frame by prepending the Ethernet header, optional Ethernet encapsulation, e.g. VLAN, the IP header, insertion of the TCP header, and appending test payload if the size of the outgoing frame calls for it. The TX processor 520 also calculates all applicable checksums. The background test streams are connectionless in nature, i.e. they transmit according to guaranteed traffic generation load rates programmed by the tester's processor 430 without regard to network loss conditions, which is different from TCP. TCP frames are transmitted when 1) TCP state machine 505 provides a TCP header and 2) the TX processor 520 indicates that a frame can be sent. A profile memory block 525 retains various encapsulations for the outgoing TCP session packets and the background traffic, i.e. Layer 2 encapsulation, IP layer addresses, and TCP port numbers. The profile memory 525 is also programmed by the test host processor 430.

The connectionless IP-based traffic and TCP traffic generated by the TX processor 520 are sent to the network interface 410.

The TCP state machine 505, the payload generator 515, the TX processor 520, and the profile memory 525 form a traffic generator 550 for providing TCP packets of at least 64 concurrent TCP sessions, and preferably 128 sessions, to the interface and for providing connectionless streams of packets of background traffic to the network interface 410. The traffic generator 550 is a part of the traffic engine 420 shown in FIG. 4.

A receiving (RX) processor 530 receives incoming traffic from the network interface 410 and performs analysis thereof. If the packet is identified as belonging to a background IP stream, the RX processor 530 performs a variety of measurements including packet counting, packet loss, packet delay, the number of lost segments, etc., on per stream basis. If it is found that the packet belongs to a TCP connection maintained by the TCP state machine 505, the TCP header from the traffic is passed to the TCP state machine 505 for further processing. Classification is based on a sextuple match of the protocol, IP Source and Destination addresses, TCP Source and Destination ports, and VLAN ID. Classification also requires all checksums to be correct. The RX processor 530 provides throughput measurements for each TCP session. The results are primarily interval based counters including received bytes. The aggregate results are calculated by the test host processor 430 and displayed via the user interface 450, for each of the concurrent TCP sessions.

The TCP state machine 505 further collects statistics per TCP session including transmitted throughput, TCP retransmissions, Round Trip Delay, Window Size, etc., and interfaces to a TCP stats engine 510, which accumulates the measurement counters in hardware on predefined time intervals. Thus the traffic engine 420 provides a measuring system for collecting statistics associated with the TCP sessions in real time. The test host processor 430 aggregates the measurements for all the TCP sessions and provides results to the user interface 450.

In operation, the tester 301 is capable of generating up to 128 TCP sessions in order to verify that the TCP throughput is sustainable under network stress conditions that are also generated by the tester device 301. The tester 301 is capable of testing in a network with link rate up to 10 GigE due to the hardware- and/or firmware-based implementation of core TCP stack functionality and IP traffic capability. Additionally, the bulk of measurements is also unique in the sense that up to 128 TCP sessions are tracked at the rates of at least 1 Gig per second. The measurement statistics include TCP retransmissions, round trip delay, lost segments, TCP receive window size, etc. The implementation of the core TCP stack functionality in FPGA and enables the key measurements which are not performed in software-based TCP implementations.

The tester 301 allows generation of the background connectionless traffic at a user definable fixed or variable bandwidth, up to the full line rate capacity, while simultaneously establishing and measuring the throughput capability of up to 128 TCP sessions. The TCP traffic is configurable based upon IP addresses, TCP ports, and TCP window size. The IP background traffic is in the form of multiple packets streams, each packet including IP source/destination addresses and UDP source destination ports.

This invention combines the test equipments capability to send and receive user configurable traffic (background IP traffic) and the capability of the TCP throughput measurement tool, at line rates up to 10 GigE, while performing measurements of TCP retransmission, TCP window size, TCP RTD, TCP probes, etc., that have never been accomplished by test tools in real time, up to 10 GigE in line rate.

By way of example, the aforedescribed method and the tester 301 may be employed as follows.

In an automated manner, the tester 300 “walks the window,” i.e. varies the window size, until it finds the optimum TCP window size for the customer network configuration. The TCP Window is one of the most important settings in terms of network performance. This setting varies greatly between operating systems and can also be affected by Layer 4 proxies and any device which regenerates TCP connections.

There are two configurable windows in TCP: the Receive Window and the Congestion or Send Window. In most cases, it is the Send Window setting which is not optimized for network latency. The Send Window must be properly tuned with the latency of the network 310 in order to achieve full throughput. The establishing of the proper Send Window size can be a complicated and tedious task, but is automated with the tester 301 “Walk the Window” script, which is a part of the software 441 executed by the processor 430. The script may use the algorithm disclosed in U.S. Application No. 20050213586 filed Feb. 4, 2005, in the name of Cyganski et al., incorporated herein by reference.

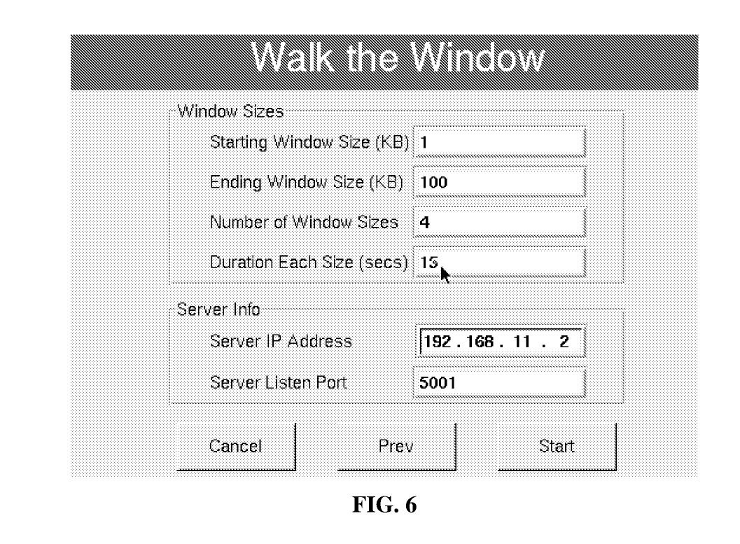

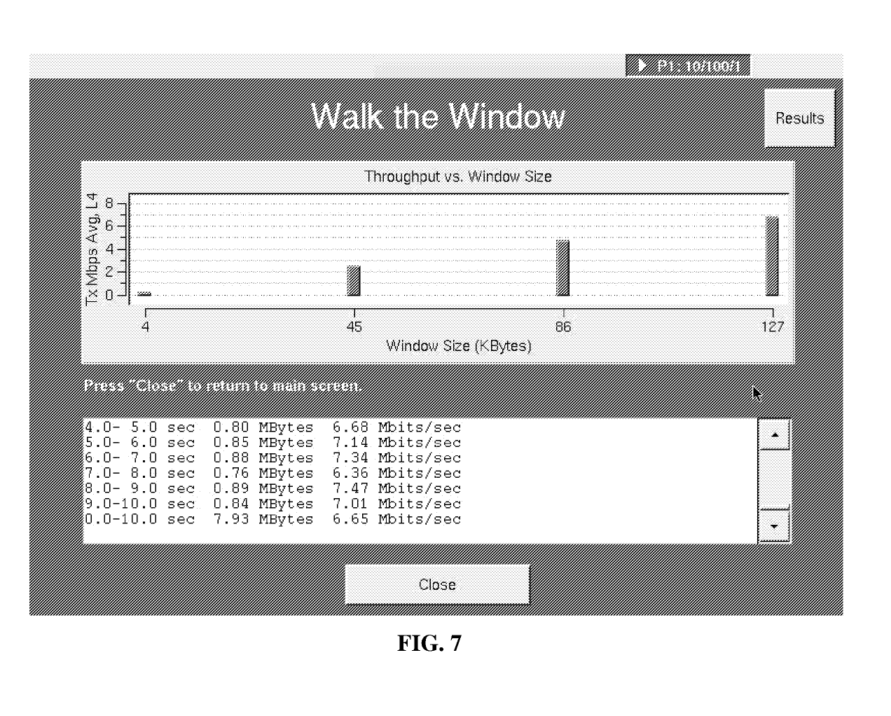

After the Walk the Window script is activated, the user configures the starting and ending Window sizes, the number of Windows to test between the starting and ending Window size, and the duration of each trial test, as illustrated in FIG. 6. The tests are then run between a first tester 301 acting as the tester 300 and a second tester 301 acting as the remote device 330. After completion, a test report is presented to the user; the report highlights the window size versus throughput performance, see FIG. 7.

Once the optimum Window size is established, TCP throughput testing may be conducted with a mixture of background traffic such as UDP to verify customer throughput under realistic network conditions. Router queue settings are a common cause of customer throughput issues and cannot be diagnosed unless a network is under load. TCP Tail Drop issues are surprisingly widespread in networks and often go undetected until a customer exceeds a particular traffic threshold.

In properly configured routers, the buffer mechanism should be set to periodically drop packets when the router becomes congested. Various “Early Discard” algorithms are used by routers so as to alleviate congestive situations. If a router is not configured properly, the buffer fills and the router drops the “tail” of the buffer. This causes a sequential block of packets to be dropped and can adversely effect the built in retransmission mechanisms of TCP. The net result is that the multitude of TCP host (servers, PCs, etc.) begins to retransmit in synchronicity, which can cause an endless loop of router congestive overload and discards. The net effect to the user is an incredible slowdown in TCP sessions such as HTTP, and in many cases is the cause of the infinite “spinning hourglass” on Windows workstations.

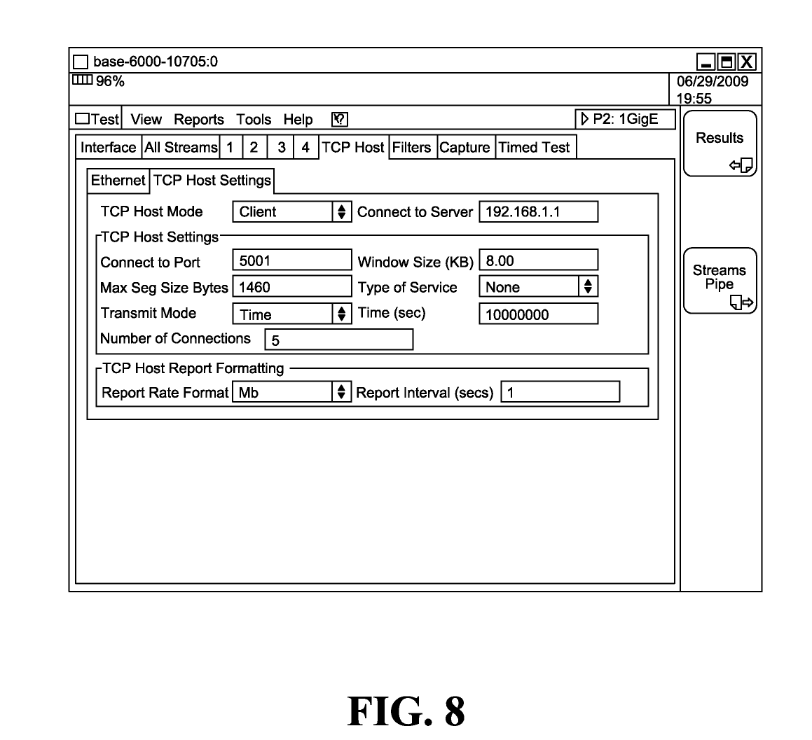

The tester 301 provides for full background traffic loading and representative TCP foreground testing at line rates up to 10 Gbps. The TCP foreground traffic simply appears as another stream in the multiple streams configuration. With reference to FIG. 8, the configuration of the tester 300 foreground sessions is accomplished by setting the IP address of the remote device 330, remote TCP Port, Window Size, Max. Segment Bytes, etc.

The setup of the TCP stream shown in TCP Host tab is simple (FIG. 8) and the user will generally set the Window size to the optimum size that was automatically determined in the Walk the Window script. Each background stream can be configured as Layer 3 or 4 traffic, UDP or TCP, with various encapsulations, such as VLAN, Q-in-Q, DSCP, etc. Each background stream can also be allocated specific throughput, frame sizes, and constant or ramp traffic profiles.

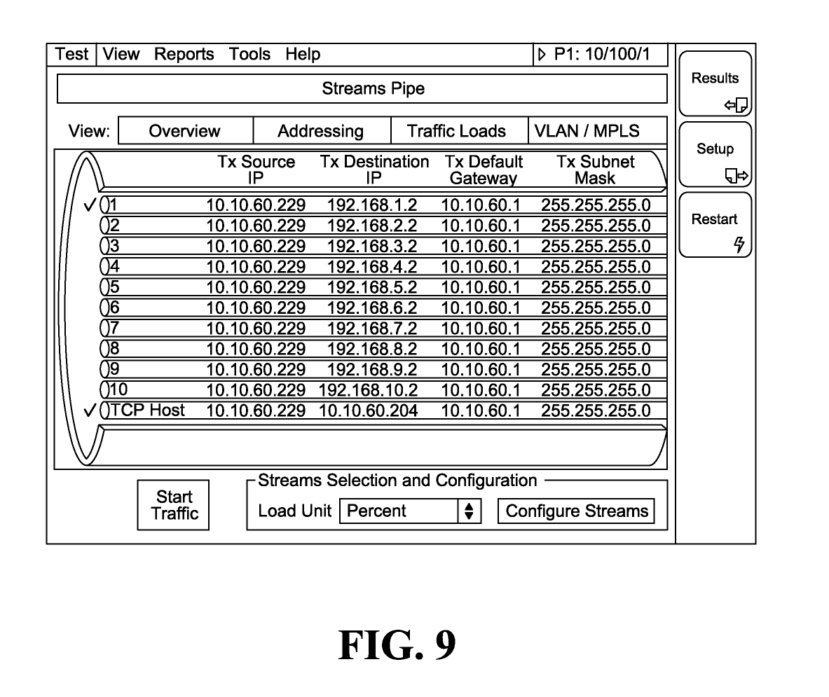

After configuring the TCP foreground and IP background streams, the user is able to review the network load profile to understand graphical “network pipe” diagram. This network pipe diagram summarizes the relative bandwidth allocated to each stream, traffic load type, and other pertinent network settings, as illustrated in FIG. 9.

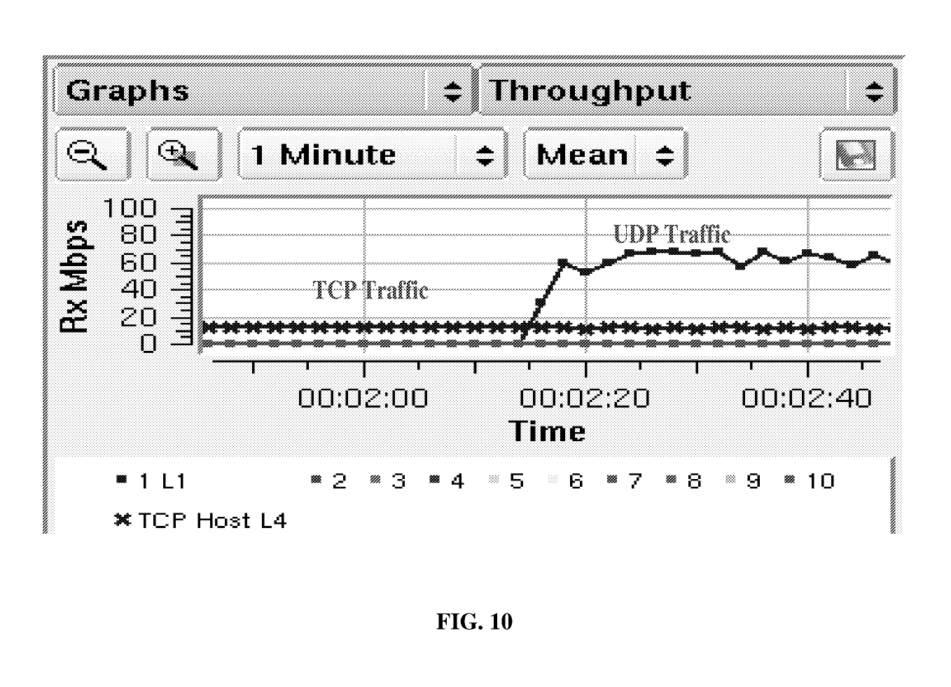

The primary goal of TCP and background testing is to verify that TCP throughput is sustainable under network stress conditions and thus to detect incorrect CoS settings and router queuing issues. By viewing the chart of TCP stream versus the background IP stream throughput, it is very easy to determine whether or not the TCP throughput was preserved under network load, which may be caused by excessive UDP traffic of streaming audio or video. In FIG. 10, it is obvious that TCP throughput is maintained in the midst of increasing UDP traffic load.

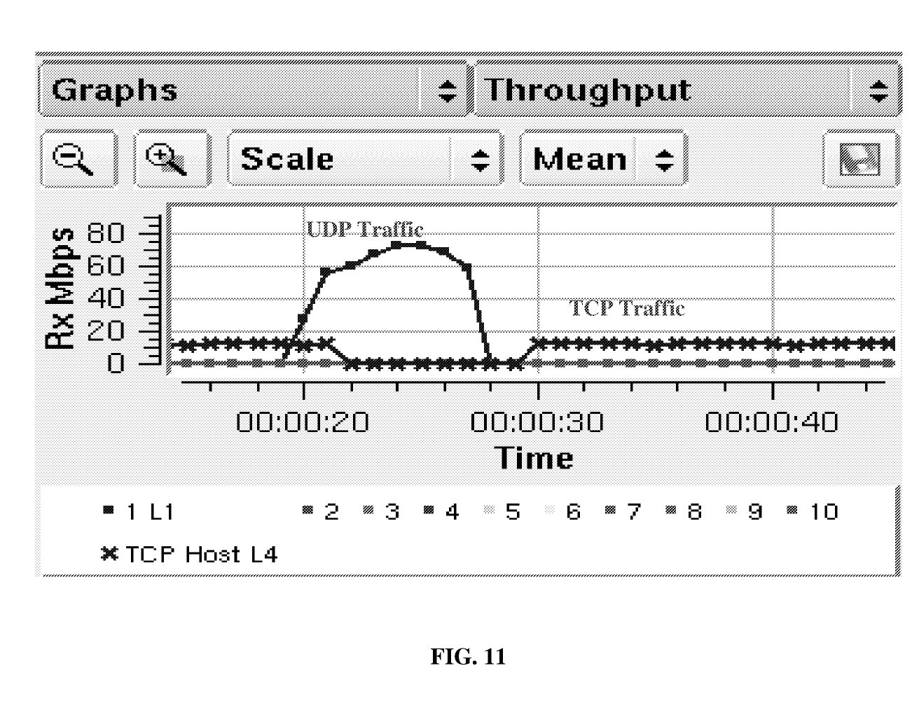

FIG. 11 demonstrates the condition where a router is not set to prioritize TCP versus UDP traffic. In this case, the TCP traffic experiences loss, which in turn degrades user application performance due to TCP retransmissions.

After the Layer 4 TCP performance is verified and proper settings are established, the application turn-up testing can commence up the stack to FTP and then HTTP.

We claim:

1. A method for real time testing of TCP traffic in a network comprising:
(a) connecting a tester to the network;
(b) requesting connectionless traffic from a remote device connected to the network, to the tester;
(c) generating the connectionless traffic comprising a plurality of packet streams, with the remote device, and receiving the connectionless traffic by the tester;
(d) generating TCP traffic comprising a plurality of TCP sessions between the tester and the remote device; and,
(e) concurrently with steps (c) and (d), in real time collecting statistics of the TCP sessions using the tester.

2. The method according to claim 1, wherein the streams of connectionless traffic are simulated streams formed of packets utilizing stuffing bytes as payload, with video, voice or data stream header parameters.

3. The method according to claim 2, wherein the packets are IP packets.

4. The method according to claim 2, wherein the packets are transmitted at a rate of at least 1 Gigabit per second.

5. The method according to claim 4, wherein the TCP traffic is transmitted at a rate of at least 1 Gigabit per second.

6. The method according to claim 2, wherein the packets are transmitted at a rate of 10 Gigabit per second.

7. The method according to claim 6, wherein the TCP traffic is transmitted at a rate of 10 Gigabit per second.

8. The method according to claim 4, wherein the tester has an FPGA-implemented traffic engine for processing packets received at the rate of at least 1 Gigabit per second, and for collecting statistics of the TCP sessions.

9. The method according to claim 8, wherein the statistics comprise a number of TCP retransmissions, a round trip delay parameter, and a number of lost segments.

10. The method according to claim 1, wherein the TCP sessions are initiated by the tester.

11. The method according to claim 1, wherein the TCP sessions are initiated by the remote device.

12. A portable tester for real-time testing of a TCP throughput in a network, comprising:
an interface for transmitting and receiving packets over the network at a rate of at least one gigabit per second;
a traffic generator for providing TCP packets of at least 64 concurrent TCP sessions to the interface and for providing background traffic to the interface, the background traffic formed of simulated connectionless streams of packets;
a measuring system for collecting statistics associated with the TCP sessions in real time; and,
a test controller for controlling the traffic generator for providing the background traffic concurrently with the TCP sessions so as to measure the TCP throughput in dependence on the background traffic.

13. The portable tester according to claim 12, wherein the traffic generator comprises an FPGA-implemented TCP state machine.

14. The portable tester according to claim 13, wherein the interface is an Ethernet interface.

15. The portable tester according to claim 14, wherein the interface is an Ethernet interface for transmitting packets over a network at a rate of ten gigabit per second.

16. The portable tester according to claim 14, wherein the statistics of the TCP sessions comprise a number of TCP retransmissions, a round trip delay parameter, and a number of lost segments.

17. The portable tester according to claim 14, wherein the test controller controls the background traffic generator so as to generate the background traffic, which utilizes a predetermined bandwidth.

18. The portable tester according to claim 14, wherein the traffic generator is for providing 128 concurrent TCP sessions.
